(19) United States
(12) Patent Application Publication
(10) Pub. No.: US 2009/0265353 A1
(43) Pub. Date: Oct. 22, 2009

(54) METHOD AND SYSTEM FOR EXTENDING ROLE BASED ACCESS CONTROL ACROSS NETWORK FILE SYSTEMS

(76) Inventor: Murali Vaddagiri, Bangalore (IN)

Correspondence Address: IBM CORPORATION;INTELLECTUAL PROPERTY LAW, 11501 BURNET ROAD, AUSTIN, TX, 78758, US

(21) Appl. No.: 12/104,098

(22) Filed: Apr. 16, 2008

(51) Int. Cl. G06F 17/30

(52) U.S. Cl. 707/9; 707/E17.007

(57) ABSTRACT

A method and system are disclosed for managing access to files in a data processing network including a server computer, a client computer, and a network file system. The network file system is used to mount the files on the server computers, and a defined group of privileges are available to those files. In the operation of the network, a process runs on the client computer, and the process generates a request for a file operation. The method comprises the steps of determining whether the process has a specified privilege for the file operation; and when the process has this privilege, modifying the request to include a signal to the server to honor the request of the process. In the preferred embodiment of the invention, the client determines whether the process has the specified privilege and makes an appropriate modification to the request.

### CROSS-REFERENCE TO RELATED APPLICATIONS

This application is related to U.S. application Ser. No. 12/049,367 filed Mar. 16, 2008, the complete disclosure of which, in its entirety, is herein incorporated by reference.

### BACKGROUND OF THE INVENTION

1. Field of the Invention

This invention generally relates to access control in a computer network, and more specifically to a role-based access control to resources in a computer network. Even more specifically, the preferred embodiment of the invention relates to role-based access control in a computer network employing a network file system.

2. Background Art

Access control relates to the moderation and limitation of access rights to resources in a computing system. Resources can range from documents to application logic, and access rights can range from read-only access to full read, write and execute access. Oftentimes, access control can vary from user to user depending upon the trustworthiness of the user. Those having a higher level of trust are granted access permissions associated with a high degree of access, while those having a lower level of trust are granted only an amount of access permission required to achieve a specific objective. In this way, the exposure of the security and integrity of the underlying resources can be minimized.

Access control for an application having only a limited number of users can be relatively manageable. For each individual user, a requisite level of access can be determined subjectively, and corresponding access rights can be assigned to the user. For an application which involves a vast number of often unpredictable individual users, access control can be unmanageable. Where the requisite access rights change for individual users in the latter scenario, access control can be a very difficult proposition. In consequence, the notion of role-based access control evolved.

Role-based access control (RBAC) relates to the assignment of access rights not to an individual user, but to a role fulfilled by one or more individual users. Specifically, it can be more readily determined what level of access rights are to be afforded to a user who fulfills a particular role in an application, such as an administrator, guest, manager, executive and the like. In the concept of workflow, roles can be extended to the type of user responsible for a portion of a business process. In this way, though the identity and roles assumed by any one user can be fluid in nature, the access rights afforded to a user assigned to a specific role can remain relatively static. Consequently, the management of access rights, even for a vast number of users, can be dramatically simplified.

Typically, most operating systems implement RBAC using two entities—roles and privileges. Users are assigned roles that enable them to execute privileged commands. Furthermore, the process is assigned privileges that the operating system kernel checks to determine if the process is authorized to perform privileged operations. As an example, if the user Joe was assigned FileSystemManagement role, and when he tries to remove a file that is not owned by him, then the operation will succeed since the process possessed appropriate privileges.

Difficulties may be encountered when RBAC is used with a Network File System (NFS). In particular, on computer networks or systems where some of the filesystems are NFS mounted, the process that tries to perform certain privileged file system operations such as: 1) remove, files; 2) open files; 3) change attributes of files such as ownership, timestamp et al.; and 4) any other operation that is supported by the NFS protocol, may not succeed. This is because the NFS server that listens to and handles client requests such as those mentioned above, does not understand and honor the privileges possessed by the process running on the NFS client.

A network file system (NFS) is a client-server application that allows network users to manage files, on several computers inside a network as if these files were on the local hard disk. Some computer systems, especially those running a Microsoft operating system such as Windows, generally attach all branches (file systems or directories) of a directory tree upon startup. However, UNIX-based computer systems typically do not do so. UNIX-based systems usually only attach certain branches to the directory tree on startup. These attached branches contain files that are critical for the operating system to function properly. The other file systems are mounted only when needed. Thus in the current UNIX world, when a user on one machine attempts to access information within a file system on a different machine, the user must perform some kind of network mount to establish a connection between the two machines. Many networked installations currently perform mounts by using a network file system (NFS) protocol, such as Network File System version 4 (NFSv4). NFS is a distributed file system protocol that provides remote access to shared files systems across networks. With NFS, computer systems connected to a network operate as clients when accessing remote files and as servers when providing remote users access to local shared files.

When a user on machine A wants access to files on machine B, the user mounts the file system from a server machine, and thus integrates the file system into the machine A's directory tree. The user also specifies where in the directory tree the files should appear. The directory given is called the mount point. A mount point is an empty directory or subdirectory that is created as a place to attach a remote file system. If the user on machine A wants to access information in another file system on machine B, the user must perform another network mount to establish another connection between the two machines in order to do so.

Both role-based access control and Network File Systems provide important advantages and are very useful. However, as mentioned above, some RBAC features may not work, or may not work effectively, when used with a Network File system.

### SUMMARY OF THE INVENTION

An object of this invention is to improve role-based access control in a computer network.

Another object of the present invention is to extend role-based access control capabilities across a network file system.

A further object of the invention is to configure,an NFS client to give instructions, under defined conditions, to an NFS server to honor certain request from a process running on the NFS client.

These and other objectives are attained with a method and system for managing access to files in a data processing network including a server computer, a client computer, and a network file system. The network file system is used to mount the files on the server computer, and a defined group of privileges are available to those files. In the operation of the network, a process runs on the client computer, and the process generates a request for a file operation. The method of this invention comprises the steps of determining whether the process has a specified privilege for the file operation; and when the process has that specified privilege, modifying the request generated by the process to include a signal to the server to honor the request of the process.

In the preferred embodiment of the invention, the client computer determines whether the process has the specified privilege, and, even more specifically, the operating system of the client computer makes this determination. Also, in this preferred embodiment, the client computer makes any appropriate modification to the request generated by the process running on the client computer; and for example, this modification may be a modification to the user id of that process.

In the implementation of a role-based access control in a computer network employing a network file system (NFS), if a file system was root exported to the NFS client, then the NFS server respects an otherwise unauthorized client request only if the process' user id was “0.” The preferred embodiment of the invention addresses this issue in the following manner. The NFS clients to whom directories are root exported from the NFS server, send a request to NFS server to perform file operations. The request contains several entities such as file name, type of operation, user id of the:process on the NFS client that made the request. Note that the privileges possessed by the process are not sent to the NFS server. Had these privileges been sent across the wire, the NFS server could have considered the request as authorized.

As an alternative, if the NFS client finds that the process making the request to the server had privileges (regardless of it's user id), then the user id of the requesting process will be modified to ‘0’ thereby ensuring that the NFS server will honor the request as authorized.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 depicts a representation of a network of data processing systems in which the present invention may be implemented.

FIG. 2 is a block diagram of a data processing system that may be implemented as a server of the network of FIG. 1.

FIG. 3 is a block diagram illustrating a data processing system that may be implemented as a client of the network of FIG. 1.

FIG. 4 shows the operation of an NFS client and NFS server in the preferred embodiment of the invention.

FIG. 5 is a flow chart showing processing steps performed by the NFS client, in the preferred embodiment of the present invention.

### DETAILED DESCRIPTION OF THE PREFERRED EMBODIMENTS

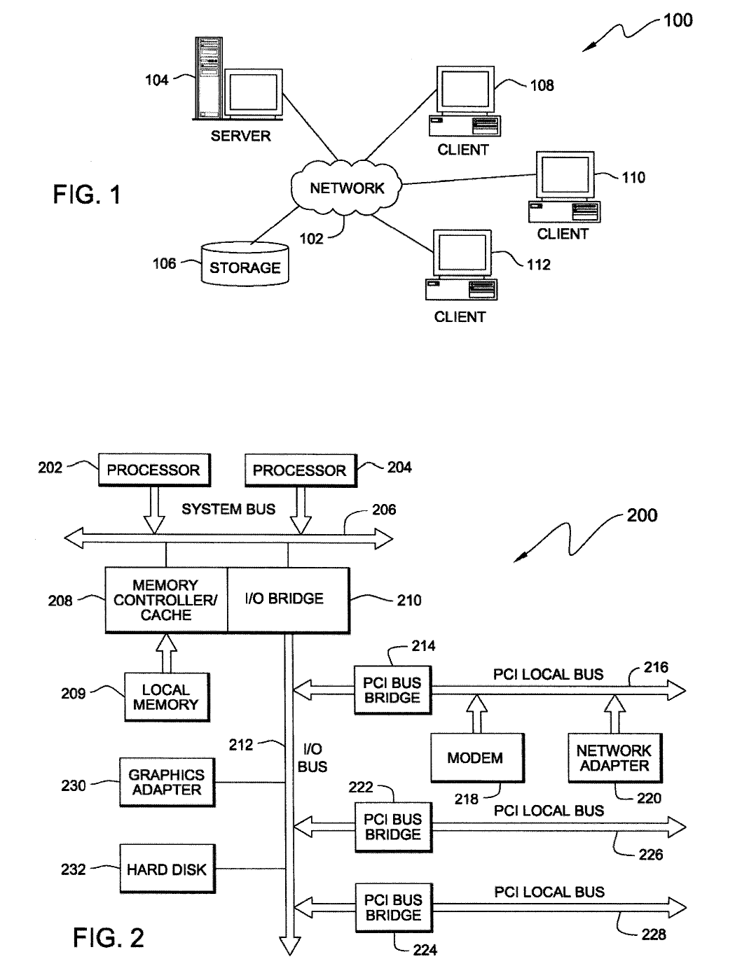

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. These files are stored by the server in a filesystem. The clients also store files in a filesystem. These file systems may include, for example, a Windows NT™ filesystem (NTFS), a Windows™ based filesystem such as FAT32, an AIX file system, a UNIX file system such as System V Release 4 (SVR4), and a Linux file system.

Network data processing system 100 may include additional servers, clients, and other devices not shown. In the depicted example, network data processing system 100 is the Internet, with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, comprised of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product, of International Business Machines Corporation in Armonk, N.Y., running the Advanced Interactive Executive (AIX) operating system or LINUX operating, system.

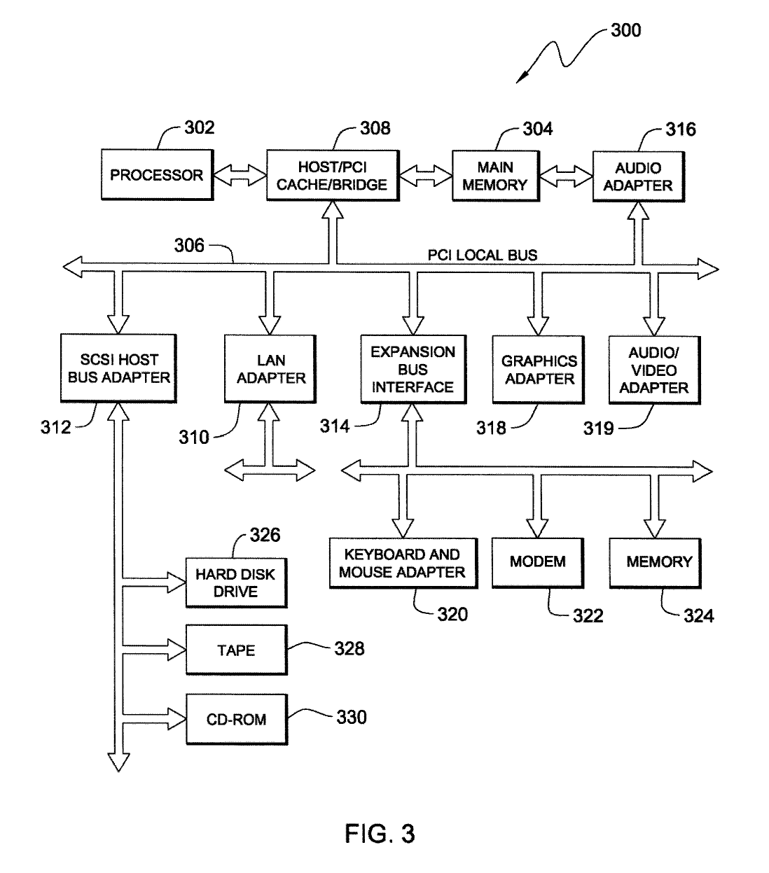

With reference now to FIG. 3, a block diagram illustrating a data processing system is depicted that may be implemented as a client computer in FIG. 1. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another-example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Network 100 employs a network file system (NFS) to manage files. NFS is, as mentioned above, a client-server application that allows network users to manage files on several computers inside a network as if those files were on the local hard disk. With NFS, when a user on machine A wants access to files on machine B, the user mounts the file system from a server machine, and thus integrates the file system into the machine A's directory tree. The user also specifies where in the directory tree the files should appear. The directory given is called the mount point. A mount point is an empty directory or subdirectory that is created as a place to attach a remote file system. If the user on machine A wants to access information in another file system on machine B, the user must perform another network mount to establish another connection between the two machines in order to do so.

For example, a user on client machine A wants to gain access to, three different file systems on server machine B. These file systems may be named “/usr”, “/usr/local”, and “/usr/local/bin”. In response to the request from the user on machine A, the system administrator on server machine B exports those three file systems, “/usr”, “/usr/local”, and “/usr/local/bin”, allowing access for client machine A. By exporting the file systems, the file systems become available for the system administrator to mount on machine A. In response, system administrator on machine A establishes a connection using an NFS mount for exported file system “/usr”. Once the exported file system “/usr” is mounted, data within the “/usr” file system is now available to the user on machine A.

For security purposes, network 100 also uses a role-based access control. RBAC (Role-Based Access Control) is intended to facilitate the management of permissions in large centralized and distributed operating systems, by distributing, reviewing, and revoking permissions for objects to roles, rather than directly to individual users, and controlling users' permissions by granting or revoking them membership to appropriate roles. Furthermore, users can be reassigned from one role to another, without requiring any explicit permission distribution or revocation action by administrators at the object level (e.g., modifying access control lists, or permission bits of capabilities). Roles can be granted new permissions as new applications and objects become accessible, and permissions can be revoked from roles whenever necessary. Hence, a role is comprised of a group of users with the same responsibilities and tasks and, at the same time, of a set of permissions authorizing the operations necessary to perform user tasks.

In the implementation of a role-based access control in a computer network employing a network file system (NFS), the NFS server may not give a requesting process its full range of privileges. In particular, if a file system was rooted to the NFS client, then the NFS server respects an otherwise unauthorized client request only if the process' user id is “0.”

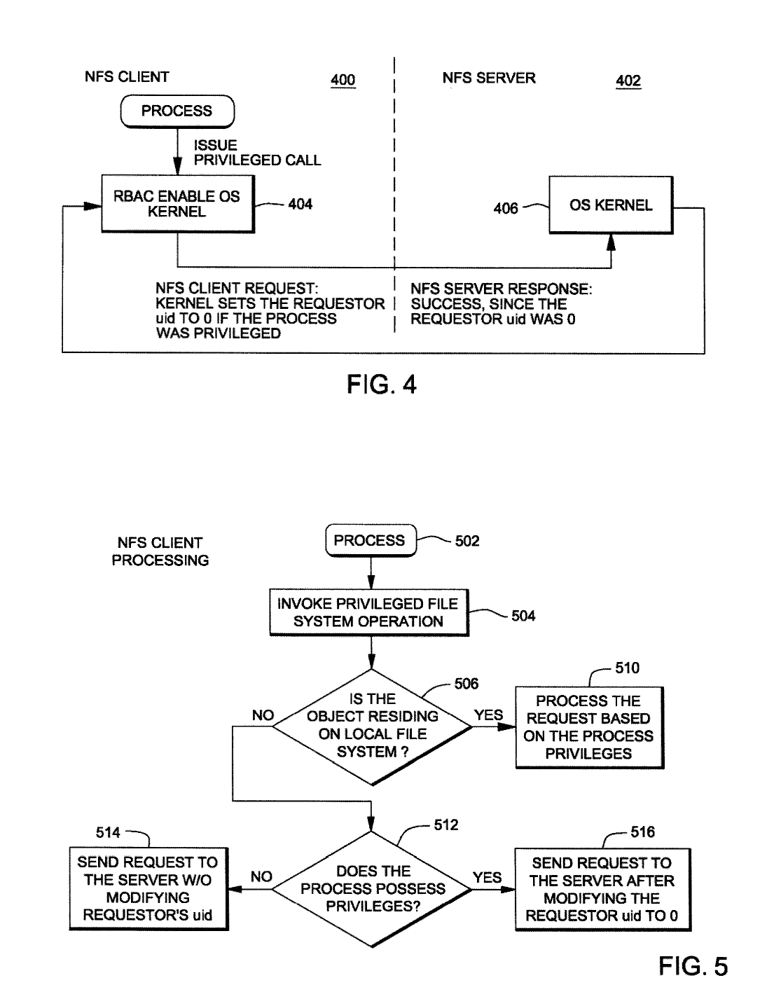

The present invention effectively addresses this issue. Generally, in accordance with the present invention, and with reference to FIG. 4, when an NFS client 400 finds that a process making a request to the NFS server had privileges (regardless of the process' user id), then the NFS client, at 404, modifies the user id of the requesting process to “0,” thereby ensuring that the NFS server 402 will honor the request as authorized.

More specifically, the kernel of the client operating system provides various services to the applications running on the client. Some of the routines within the kernel check for privileges before allowing privileged operations. The kernel is coded in such a manner so as to check for specific privileges in various system calls and kernel services. For file system specific operations, if the kernel finds that the target object resides on the NFS server 402, and if the process possessed the corresponding privileges, the kernel will set the requester user id to 0 in the NFS request that is sent through the wire to the NFS server. This way the request is guaranteed to succeed, at, 406, since the NFS server will honor user id 0 if the filesystem was root exported to the NFS client.

FIG. 5 illustrates processing steps performed by the NFS client in the preferred method embodying this invention. A process, represented at 502, invokes a privileged file system operation at step 504. At step 506, the client operating system determines if the requested object resides on the local file system. If the requested object is local, then at step 510, the request is processed based on the process' privileges. However, if the requested object is not local, then, at step 512, the kernel of the client, operating system determines if the process 502 possesses privileges. If the requesting process does not possess the privilege, then, at step 514, the request is sent to the NFS server without modifying the requesting user id. In contrast, if the requesting process does possess privileges, then, at step 516, the request is sent to the NFS server after the client kernel modifies the requester user id to “0.”

The preferred embodiment of the invention thus extends RBAC capabilities across networks using NFS. The present invention can be used in many specific situations. For example, this invention could be used to implement RBAC on diskless systems. Since the file systems on such systems are NFS mounted, the privileged process can make a request to the server in such a way that the server understands that the request came from a privileged process that is sitting on the client.

As will be readily apparent to those skilled in the art, the present invention, or aspects of the invention, can be realized in hardware, software, or a combination of hardware and software. Any kind of computer/server system(s)—or other apparatus adapted for carrying out methods described herein—is suited. A typical combination of hardware and software could be a general-purpose computer system with a computer program that, when loaded and executed, carries out the respective methods described herein. Alternatively, a specific use computer, containing, specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of managing access to files in a data processing network including a server computer, a client computer, and a network file system for managing access to files, and wherein a process runs on the client computer, and a defined group of privileges to the files are available to the process, the method comprising the steps of:
using the network file system to mount a group of files on the server computer;
the process generating a request for a file operation;
determining whether the process has a specified privilege for the file operation; and
when the process has said specified privilege, modifying said request to include a signal to the server to honor the request of the process s.

2. A method according to claim 1, wherein the step of determining whether the process has the specified privilege includes the step of the client computer determining whether the process has said specified privilege.

3. A method according to claim 2, wherein the client, computer has an operating system, and the step of the client computer determining whether the process has said specified privilege includes the step of said operating system determining whether the process has said specified privilege.

4. A method according to claim 1, wherein the step of modifying said request includes the step of the client computer modifying said request.

5. A method according to claim 1, wherein the process has a process identification, and the step of modifying said request includes the step of modifying said process identification.

6. A method according to claim 1, wherein the request identifies a target object, and the determining step includes the step of determining if said target object is on the server computer.

7. A method according to claim 6, wherein the step of determining if said target object is on the server computer includes the step of said client computer determining if said target object, is on the server computer.

8. A method according to claim 1, wherein the request identifies a target object, and the method comprises the further steps of:
determining if the target object is on the client computer; and
when the target object is on the client computer, processing the request on the client computer based on said specified privilege.

9. A method according to claim 8, wherein the step of determining whether the process has the specified privilege includes the step of, when the target object is not on the client computer, determining whether the process has the specified privilege.

10. A method according to claim 9, comprising the further step of:
when the target object is not on the client computer, and the process does not have the specified privilege, sending the request from the client computer to the server computer without modifying the request.

11. A system for managing access to files in a data processing network including a server computer, a client computer, and a network file system for mounting files on the server computer, and wherein a process runs on the client computer and generates a request for a file operation, and a defined group of privileges to the files are available to the process, the system comprising:
one or more processing units on the client computer and configured for determining whether the process has a specified privilege to a defined file; and when the process has said specified privilege, for modifying said request to include a signal to the server to honor said request generated by the process.

12. A system according to claim 11, wherein the client computer has an operating system, and said operating, system is used to determine whether the process has said specified privilege.

13. A system according to claim 11, wherein the process has a process identification, and said one or more processing units are configured to modify said process identification when the process has said specified privilege.

14. A system according to claim 11, wherein the request identifies a target object, and the one or more processor units are configured to determine if said target object is on the server computer.

15. A system according to claim 11, wherein the request identifies a target object, and the one or more processor units are configured for:
determining if the target object is on the client computer;
when the target object is on the client computer, processing the request on the client computer based on said specified privilege;
when the target object is not on the client computer, determining whether the process has the specified privilege; and
when the target object is not on the client computer, and the process does not have the specified privilege, sending the request from the client computer to the server computer without modifying the request.

16. A computer readable storage media, tangibly embodying a program of instructions executable by the computer to perform method steps for managing access to files in a data processing network including a server computer, a client computer, and a network file system for mounting files on the server computer, and wherein a process runs on the client computer and generates a request for a file operation, and a defined group of privileges to the files are available to the process, said method steps comprising:
determining whether the process has a specified privilege to a defined file; and
when the process has said specified privilege, modifying said request to include a signal to the server to honor the request generated by the process.

17. A computer readable program storage media according to claim 16, wherein the client computer has an operating system, and said operating system is used to determine whether the process has said specified privilege.

18. A computer readable program storage media according, to claim 16, wherein the process has a process identification, and the modifying step includes the step of modifying said process identification when the process has said specified privilege.

19. A computer readable program storage media according to claim 16, wherein the request identifies a target object, and the method steps comprise the further step of determining if said target object is on the server computer.

20. A computer readable program storage device according to claim 11, wherein the request identifies a target object, and the method steps comprise the further steps of:
determining if the target object is on the client computer;
when the target object is on the client computer, processing the request on the client computer based on said specified privilege; and
when the target object is not on the client computer, and the process does not have the specified privilege, sending the request from the client computer to the server computer without modifying the request.
